(19) United States
(12) Patent Application Publication
(10) Pub. No.: US 2013/0135465 A1
(43) Pub. Date: May 30, 2013

(54) OPTO-ELECTRONIC SYSTEM FOR RADIOMETRIC MEASUREMENTS

(71) Applicants: Donato Vincenzi, Cento (IT); Massimiliano Occhiali, Ferrara (IT); Stefano Baricordi, Ro (IT); Carlo Ferrigno, Padova (IT)

(72) Inventors: Donato Vincenzi, Cento (IT); Massimiliano Occhiali, Ferrara (IT); Stefano Baricordi, Ro (IT); Carlo Ferrigno, Padova (IT)

(21) Appl. No.: 13/702,984

(22) PCT Filed: May 31, 2011
(86) PCT No.: PCT/IB11/52399

§ 371 Date: Feb. 19, 2013

(30) Foreign Application Priority Data
Jun. 8, 2010 (IT) BO2010A000361

(51) Int. Cl. H04N 7/18

(52) U.S. Cl. 348/135

(57) ABSTRACT

An electro-optical system for the carrying out of radiometric measurements of luminous sources comprises an instrument equipped with: a sensor comprising a pixel matrix, an optical system for creating the image of an external luminous source on the sensitive surface of the sensor, an optical bandpass filter, interposed between the sensor and the external luminous source for separating the spectrum of radiation emitted by the external luminous source into two portions: the first portion having a relatively limited bandwidth is transmitted toward the sensor while the second does not reach the sensor; moreover, the system comprises a computer which, starting from the plurality of monochromatic images recorded from the sensor, allows the calculating both of the angular distribution of the incident luminous radiation on the instrument and the irradiance on the normal plane in the direction from which the luminous radiation originates.

### TECHNICAL FIELD

The present invention concerns an electro-optical system, for radiometric measurements and in particular a system which is able to carry out both the measurements of direct solar irradiance and the evaluating of the precision with which the optical axis of reference of such instrument is orientated toward the Son.

### BACKGROUND ART

Some solar systems, photovoltaic or thermal, are set into motion by appropriate mechanical structures in such a way that they are always orientated perpendicularly to the direction of the solar radiation, therefore, allowing a more effective collection of the power emitted by the Sun.

The photovoltaic and thermal solar systems am turned to convert solar radiation into electrical or thermal energy. Said systems are commonly exposed to the solar radiation orientating their active surfaces toward the south and inclining them at a suitable angle (called ‘elevation’) as regards the horizon, in such a way as to optimize the angle between the solar radiation and the perpendicular of the active surface. This solution allows the maximizing of the efficiency of the collection of solar radiation during the hours of greater radiation.

In some eases, these solar systems are mounted on mechanical or electro-mechanical structures which are able to follow the Sun in its apparent movement and, therefore, they allow such systems always to be orientated perpendicularly to the direct solar radiation, or rather, to the radiation which arrives directly from the solar disc. This system, as well, allows the maximising of the efficiency of the collection of solar radiation over the range of the whole day. Some particular solar systems called “concentration” make use of optical systems such as lenses or mirrors to concentrate the solar radiation on active elements of small dimensions. Such active elements can fee photovoltaic cells which are capable of generating. electrical energy, or thermal receivers which are capable of converting the solar radiation into teat.

In both cases, the optical system of concentration allows the very effective collecting only of the solar radiation which falls inside an imaginary cone whose semi-opening is called angular “acceptance”. The axis of such a cone is typically defined as the optical axis of the system. In comparison to plane solar systems, concentration solar systems have an extremely reduced acceptance angle and, to guarantee optimal collection efficiency, it is indispensible that the optical axis of the system, be precisely aligned in the direction from which the solar rays originate.

Even if the acceptance angle in this case is typically of several degrees, the necessity of the correct alignment with the solar radiation turns out to be valid even in the case of plane solar systems. Solar tracking systems are typically equipped with electronic logic control capable of supplying indications to the attenuators so as to allow the conversion systems to constantly find the optimal angle of inclination, that is, to align the optical axis of the systems with the direction from with the solar rays originate.

Such electronic control systems can make use of astronomical coordinates (ephemerides) of the Sun for a given day and for a given hour, or use alignment sensors which supply a direct indication of the inclination as regards the direction of the solar radiation.

The precision typical of tracking systems strongly depends on the typology of the conversion system used. In the case in which flat panels are coupled, both photovoltaic and thermal, the tolerable error is typically of several degrees, while in the case of concentration systems the tolerable error is typically of a few tenths of a degree.

The producers of solar tracking systems usually specify the precision with which the system: Is able to align, itself in the direction of solar radiation, however, the instrumental proof of this indication is very rarely furnished. Furthermore, the alignment error can depend on environmental conditions (force of the wind, thermal deformation, clouds) or by contingent conditions (dust accumulated on the positioning optical sensors, errors in the timetable used for the calculation of the solar ephemerides)

The use of an instrument preset for the measurement of angular precision with which the movement system tracks the Sun is, therefore-, of extreme importance for supplying a quantitative indication of the error committed and of the temporal advancement of such error, in such a way as to be able to conflate particular environmental conditions or contingencies.

On the market there exist a few instruments that supply this measurement and make use in some cases of CMOS (complementary metal-oxide semiconductor) or CCD (charge coupled device) sensors, m other cases are also used PSD devices (position sensitive device).

These instruments still do not allow the furnishing of an indication of direct solar irradiance, that is, of the luminous intensity that originates directly from the solar disc and, therefore, they do not allow the evaluating of the loss of power consequent to a particular error in the alignment of the conversion system with the incident solar radiation. This limitation is due to the fact that the sensitive element of the CMOS, CCD, or PSD sensors is typically made of silicon and the measurement of the luminous intensity happens by quantifying the charge photo-generated by the miniaturized electronic components called photo-diodes.

For their intrinsic feature, photodiodes have a spectral response curve that cannot be constant for all of the spectrum; as a matter of feet, once exposed to full spectrum luminous radiation such as that of the Sun, they give a response mediated by their sensitivity curve. In particular, photodiodes made of silicon cannot, convert luminous radiation with wavelengths greater than 1200 nm into electrical charges and, therefore, into useful signals, while the spectrum of solar radiation extends even into the distant infrared, that is, greater wavelengths.

Even relatively short wavelengths (under 500 nm) are not effectively converted by the silicon. This means that the outbound electrical signal of a generic device constitutes an average indication, of the intensity of the incident radiation within a particular spectral band, but does not allow precisely measuring the radiant Intensity on the full emission spectrum of the solar source.

As is known, the measurement of direct solar radiation comes about typically by means of an external instrument called a pyrheliometer which is equipped with a wide spectrum sensor (thermopile) and allows directly measuring the intensity of the incident radiation inside a cone with a total aperture of about 6 degrees. Analogously to the pointing sensors, these instruments are solidly affixed to the mechanical tracking structure and aligned with the optical axis of the systems of solar conversion. Since this has to do with an instrument which is separate from the pointing sensor, there exists the necessity of carrying out a precise alignment between the two m such a way that the radiometric measurements of the radiant intensity (irradiance) are coherent with the measurements of the tracking precision.

In other words, the instruments for the detection of the solar tracking precision typically make use of positioning sensors (CCD, CMOS or PSD) which, for their intrinsic characteristics, cannot supply precise radiometric measurements of the incident luminous intensity on the sensor. Such semiconductor sensors, based on the photoelectric effect, convert a portion of the incident photons in electric charges creating a useful signal. The different wavelengths which fall on the active surface of such sensors are converted with different efficiency and, starting from the radiant intensity, therefore, give a diverse electric response. The curve which describes the relationship between generated electric current, and the incident optical power with regard to the wavelength is called the spectral response carve of the device.

In the case of silicon devices the spectral response curve typically extends from 400 nm to 1000 nm. The outbound signal of these devices is mathematically described by the integral of the product between the spectral response curve and the power spectral density of the incident radiation. Because of the intrinsic nature of the integral function, it is not possible, starting from the outbound signal from said semiconductor devices, to go back to the spectral distribution of the incident radiation. As a consequence of this, the outbound electrical signal from a semiconductor device cannot unequivocally identify the intensity of the incident radiation unless one knows perfectly the spectrum of luminous radiation and the spectral response curve of the device,

it is known that solar radiation which reaches the surface of the earth undergoes daily and seasonal variations of its power spectral density because of the effect of absorption and of diffusion on the part of gases, of water vapour, and of dust present in the atmosphere.

To carry out the precise measurement of direct irradiance, it is necessary to make use of a wide spectrum sensor, such as she thermopile, widely used in pyranometers and pyrheliometers. This type of sensor has a spectral response which is practically constant for the whole range of wavelengths which go from 300 nm to 200 nm.

To carry out the precise measurement of radiant, intensity, it is similarly possible to use a calibrated spectroradiometer, or rather, an Instrument which supplies the curve of the power spectral density m relation to the wavelength. The integral of the toll power spectral density, at least in principle, on ail the wavelengths supplies the radiance on the plane of the sensor.

In the ease that the spectrum of the radiation to he measured presents a certain regularity and its variations are not completely arbitrary, it is not necessary to carry out measurements of power spectral density with extremely reduced wavelength intervals (as in the case of spectroradiometers based on dispersive or detractive elements), hot it is sufficient to carry out a reduced number of monochromatic measurements to arrive at a reliable description of the energetic content- of the spectrum under examination. Obviously, so that the calculation of the total irradience is precise, it is necessary that such measurements are conducted on a wide band of wavelengths in such a way as to include the ultraviolet band of the spectrum, the visible band, and the wide-hand infrared.

Document CN101398301 describes a machine for the measurement of tracking precision for a photovoltaic dual axis tracking system.

The incident light is directed by means of a light guide and through a synthetic glass, onto a semitransparent target on which are placed several concentric circular crowns, each one indicating different degrees of precision in the measurement of the tracking of the Sun. This apparatus can be assembled on the photovoltaic system, and can give a measurement of the precision of the tracking of the Sun on the basis of the point of the target on which the light is recorded.

Document CN 201043889 describes a high precision transducer for the position of the Sun comprised of a convex lens, a photosensitive diode or a photocell, and a circuit for the elaboration of the signal. The image of the Sun made by the convex lens, is channelled, onto the photocell or photosensitive diode, which allows the circuit to process the position of the Sun. This system, applied to photovoltaic systems, allows the tracking of the position, of the Sun. In the description of the patent in question, no reference is made to the precision which it is able to supply.

US 2010/0000517 (A1) describes a system in which solar light is analysed for identifying and isolating from it the part of direct radiation for solar tracking. The incident light, originating from, different directions, incises on polarisers with different angles for determining the radiation energy. Afterwards, the light is filtered with interferential filters to isolate the direct solar radiation. Finally, the light passes through a spherical lens to record on a configuration of four quadrant cells. This allows the aligning of a collection system of solar radiation is such a way as to receive the direct radiation. This apparatus is not an instrument of measure, but a position sensor which allows the aligning of a system with the direction of the radiation originating from the Sun.

Document CN101329583 describes an automatic device for solar tracking comprised of: a solar position sensor PSD (Position Sensor Detector), a chip DS1302 that supplies time and date in real time, a circuit for the elaboration of the signal, a microcomputer for the control of the chip, and a tracking mechanism. The PSD is a segmented photodiode with its sensitive area divided into several areas. On the basis of the area hit, it manages to determine the deflection of the beam and consequently the change of position of the reflecting holder.

Document US2008029652 (A1) describes a solar sensor for the maintenance of the trim of a satellite with the use of an APS (Active Pixel Sensor) as detector. The equipment is comprised this way: a diaphragm, an APS sensor, a detection unit, a computer, and an interface. The diaphragm is, in this case, a mask cut into a silicon wafer of 300 microns. The image of the Sun incises on the sensor, after being passed through the mask placed at 3.5 mm from the sensor. An image of the various son spots is thus created on the sensor. The detection unit with the CMOS APS sensor is programmed to supply the gray value of each pixel of die image acquired through the mask. The computer analyses the coordinates of each pixel on the APS and, on the basis of this data and on the gray level of each pixel, computes the angle of trim which is afterwards transferred to the computer by means of an interface. The dimensions of this apparatus are 85×85×45 mm, with a weight of 250 g. Its accuracy is of 0.05 in POV of 120×120, the update rate is 10 hz. For applications in the field of satellites a wide FOV, limited weight, and optimal precision in the determination of the trim of the satellite or of the Rover are required.

Document U.S. Pat. No. 3,876,880 describes a pyranometer for the measurement of global solar radiation within the solar spectrum. This instrument comprises three measurement heads, that is, thermoelectric detectors with hemispheric filters placed concentrically. To each detector is coupled a selective filter for the wavelengths in the infrared, visible, and ultraviolet fields respectively, to cover the entire spectrum of solar radiation. Such an instrument is equipped with a ventilation system to prevent overheating due to the absorption of greater wavelengths.

Document U.S. Pat. No. 5,455,415 describes an Isolation sensor of compact dimensions which identifies the main direction of isolation and intensity in conformity to the atmospheric conditions. Only a part of the incident beam is transmitted to a predetermined surface, spaced at a known distance, which is covered with a film, made up of semiconductors, for photoelectric conversion. The incident beam on the surface, therefore, generates an electrical signal which corresponds to the reception position of the light, determining its centre of intensity. This information is used for the correction, of a conditioning system on the basis of the main direction of isolation.

### DISCLOSURE OF THE INVENTION

in this context, the main technical purpose of the present invention is to propose a system of measurement which allows the avoiding of the above drawbacks.

One aim of the present invention is to propose a system of measurement which allows the supplying, thanks to the appropriate spectral-radiometric calibration, of both a precise indication of the direct solar intensity (irradiance) of the entire solar spectrum, and a measurement of the precision with which the optical axis of the system is aligned with respect to the direction from which the sun's rays originate.

Another aim of the present invention is to offer the possibility of integrating the measurement of the pointing: and the measurement of the irradiance In a single Instrument avoiding the use of two separate instruments (pointing sensor and pyrheliometer) and, moreover, allowing added indications derived from the elaboration of the images collected.

The specified technical task and at least the specific aims are essentially reached by a system of measurement comprising the technical characteristics explained in the attached claims.

### BRIEF DESCRIPTION OF THE DRAWINGS

Further features and advantages of the present invention are mom apparent in the detailed description below, with reference to a preferred, non-limiting, embodiment of an electro-optical system of measurement of solar irradiance, as Illustrated in the accompanying drawing, in which:

FIG. 1 shows an electro-optical system of measurement in accordance with the present invention in a lateral schematic view with several parts removed to better highlight others;

FIG. 2 shows a detail of the system of FIG. 1 in a perspective schematic view;

FIG. 3 shows an electro-optical system, of measurement in accordance, with the present invention for a second embodiment in a lateral, schematic view with some parts removed to better highlight others;

FIG. 4 shows an electro-optical system of measurement in accordance with the present invention in a perspective schematic view;

FIG. 5 shows an application of the electro-optical, system of measurement under the previous Figures, in a perspective schematic view;

FIG. 6 shows a portion of the electro-optical system of measurement in accordance with the present invention in an expanded scale and in a lateral schematic view,

FIG. 7 shows a flow chart relative to a methodology of calculation implementable by the electro-optical system, of measurement in accordance with the present invention;

FIG. 8 shows a second flow chart relative to a second methodology of calculation which can be implemented by the electro-optical system of measurement in accordance with the present invention.

### DETAILED DESCRIPTION OF THE PREFERRED EMBODIMENTS OF THE INVENTION

With reference to FIG. 1, with the number 1, an electro-optical system of measurement in accordance with the present invention is indicated.

The system I comprises an instrument of measure 100 it also being pan of the present invention.

Recent scientific studies conducted by inventors have demonstrated that the regularity of the variations of the spectrum of solar radiation is such as to allow the calculation of the global irradiance (integrated on all of the spectrum of wavelengths) starting from a reduced number of monochromatic measurements.

Such monochromatic measurements are conducted within a rather limited wavelength band, including from 300 nm to 1200 nm.

The instrument 100 allows the calculation of the global irradiance, or rather, integrated on all the spectrum of wavelengths, starting from at least one monochromatic radiation.

The instrument 100 in accordance with the present invention comprises a photoelectric sensor 101 having a pixel matrix and a printed circuit or electronic circuit 102 on which the sensor 101 is mounted.

More specifically, the instrument 100 comprises an optical camera 103 in which is enclosed the sensor 101.

The sensor 101 has a predetermined, and noted spectral response curve and a predetermined minimum exposure time (for example 0.1 ms) which corresponds to the minimum, exposure time of the sensor's pixels 101.

Moreover, the sensor 101 operated appropriately, as will be clarified further on, records the images which are created on it and it carries out a so-called shooting which corresponds to the acquisition time of the images.

The instrument 100 comprises an optical system 104 whose focal plane lies on the sensitive surface or active area 134 of the sensor 101.

In general, the optical system 104 comprises one or more lenses for focusing the luminous source observed with the instrument 100 on the sensor 101. For further simplicity, yet without losing generality, further on reference will he made to a single lens in reference to the optical system.

By centre of the system, it means the centre of the above mentioned lens.

The active area 134 and the lens of the optical system 104 define the field of view of the instrument 100.

For the instrument 100 it is also possible to define an optical axis 137.

A unit or system of data elaboration 130 is connectable to the instrument 100 by means of a communication system 110.

Advantageously, in one preferred embodiment, the communication system 110 is complete with a Universal Serial Bus (USB) connection.

Alternatively, the communication system 110 is of the wireless type.

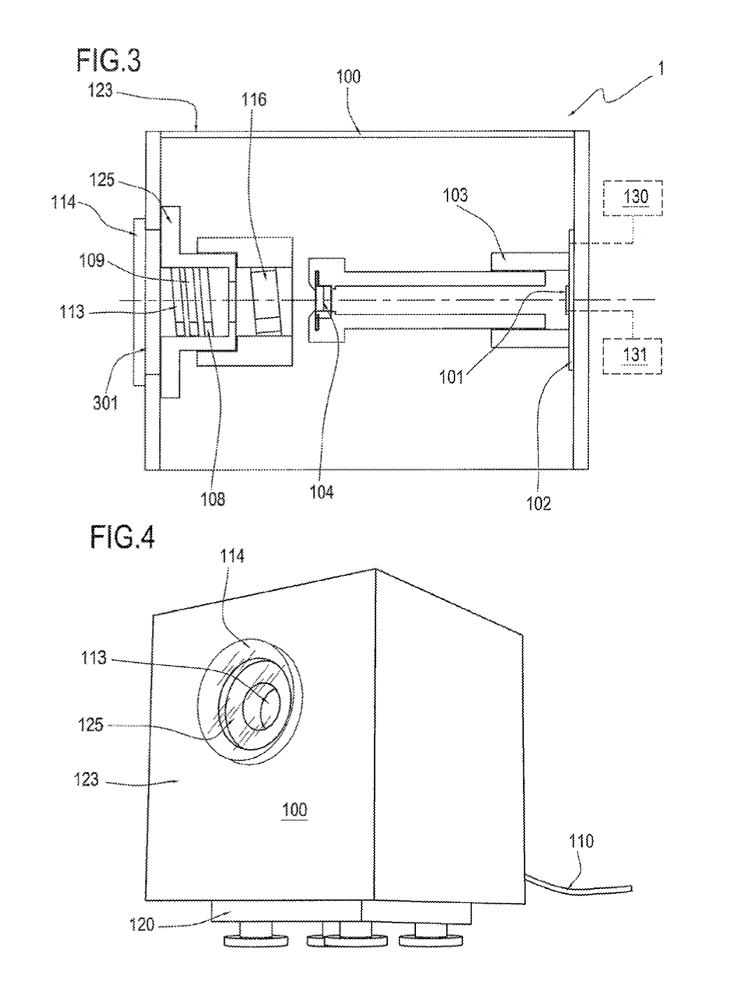

Advantageously, in one alternative embodiment, schematically illustrated in FIG. 3 by dotted line, the computer 130 is integrated inside the instrument 100.

During use, as will be clearer in the following, the sensor 101 converts the image created by the optical system 104 into an analogical or digital electrical signal which is then sent, by means of the communication system 110, to the external computer (130),

As known, for optical axis one intends the axis which is essentially identified by the centre of the sensor, or rather from the active area of the sensor and from the centre of the lens of the optical system.

Optical path means the path passing through the lens of the optical system and defined between the generic luminous source that is being observed and the centre of the sensor,

In other words, optical path means the path which the generic ray follows to reach to the sensor from the source through the optical system.

The sensor and the lens define the field of view of the instrument or rather in that area of space in which the luminous sources emit rays which, passing through the optical system, reach the sensor,

The optical path is, therefore, found within the field of view.

The instrument 100 comprises a plurality of insertable bandpass filters 105, with the modality described further on, along the optical path.

Each filter 105 has a predetermined passband.

In a preferred embodiment illustrated, the filters 105 are placed opposite the sensor 10l with respect to the optical system 104.

In other words, the filters 105 are positionable along the optical path between the luminous source 133 and the optical system 104.

With reference to the Figures, it may be observed that the filters 105 are shown inclined to avoid undesired effects of reflection of the incident waves.

The filters 105 ate configured in such a way as to separate one Incident radiation 128 into two complementary spectral bands. In practice, alternatively, the bandpass filters 105 are inserted along the optical path and separate the spectrum of the incident radiation 128 into two complementary bands.

Preferably, a first band or portion of almost monochromatic radiation 129 is transmitted toward the sensor 101 while a second, hand or portion, complementary to the first portion 129 is reflected outside the instrument 100.

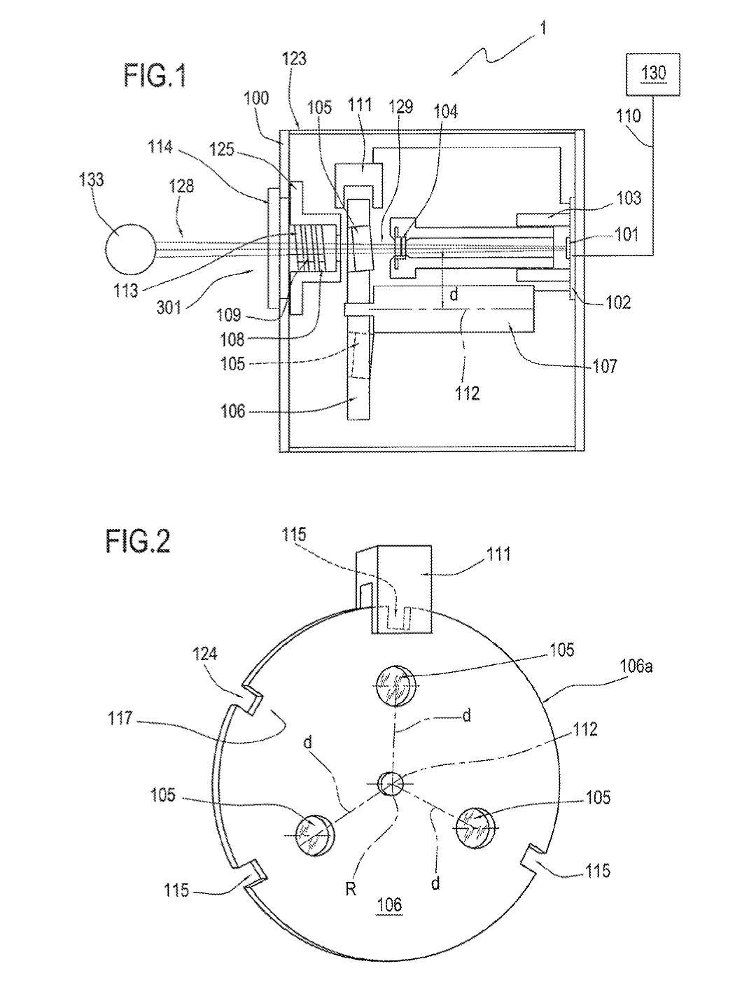

With special reference to FIGS. 1, and 2, it may be observed that the instrument 100 comprises a wheel or filter holder support 106 having a rotation axis 112.

The bandpass filters 105, three in the illustrated embodiment in FIG. 2, are supported by the wheel 106 and are placed radially and all have the same distance “d” from the rotation axis 112 of the wheel 106.

In particular, the distance “d” is that for which each filter 105 can be positioned aligned with the optical axis of the optical system 104 by means of the appropriate rotation of the wheel 106.

The instrument 100 comprises an electrical motor 107 controlled by the cited electronic circuit 102.

More in detail, the instrument 100 preferably comprises an optocoupler 111, of an essentially known type, connected to and in communication with the circuit 102 for directing the positioning of the filters 105.

In other words, the filters 105 are positioned alternatively along the optical path of the filter holder wheel 106 pat in rotation by the electrical motor 107 controlled by the electronic circuit 102.

The command for the recording of the image or shoot is supplied to the sensor 101 by the optocoupler 111 connected to the electronic circuit 102.

In particular, the optocoupler I 11 allows the giving of the command to take the picture to the sensor 101 when one of the bandpass filter 105 is inserted along the optical path.

As will he better clarified further on, the instrument 1.00 comprises a shutter element 117 or a basically opaque shutter for the luminous radiation to obscure the field of view of the optocoupler 111.

In practice, the optocoupler 111 supplies the command to take the picture to the sensor 101 when the field of view of the instrument 100 is obscured from the element 1.17, in such a way to identify the reference element of the sequence of images acquired by the sensor.

Preferably, according to what is illustrated, the instrument 100 comprises an attenuator filter 1.08 of neutral density.

Advantageously, as mentioned, the time of exposition of the sensor having a minimum limit, the attenuator filter 108 prevents too much light from reaching the sensor 101.

Advantageously, the filter 10$ is supported and kept inserted along the optical path.

Preferably, moreover, the instrument 100 comprises a protective window 109.

Preferably, the window 109 is essentially transparent.

In other words, along the optical path, there is preferably inserted the attenuator filter 108 and the protective window 109 which is essentially transparent.

In the preferred embodiment illustrated, the instrument 100 comprises a support 125 for the liter IDS and for the protective window 109.

Advantageously, the filter 108 and the window 109 are kept in position by the support 125 which takes care to keep their inclination with respect to the optical axis of the Instrument 100 constant to avoid undesired reflections toward the sensor 101.

Advantageously, the instrument 100 comprises a containment body 123 or container inside of which there is housed the sensor 101, the printed circuit 102, and the optical camera 103.

The optical system 104 is also inserted within the body 123which is provided with an aperture 301 through which the radiation of interest preferably solar, reaches the optical system 104.

The support 125 is placed essentially coaxially with the aperture 301 and with the sensor 101.

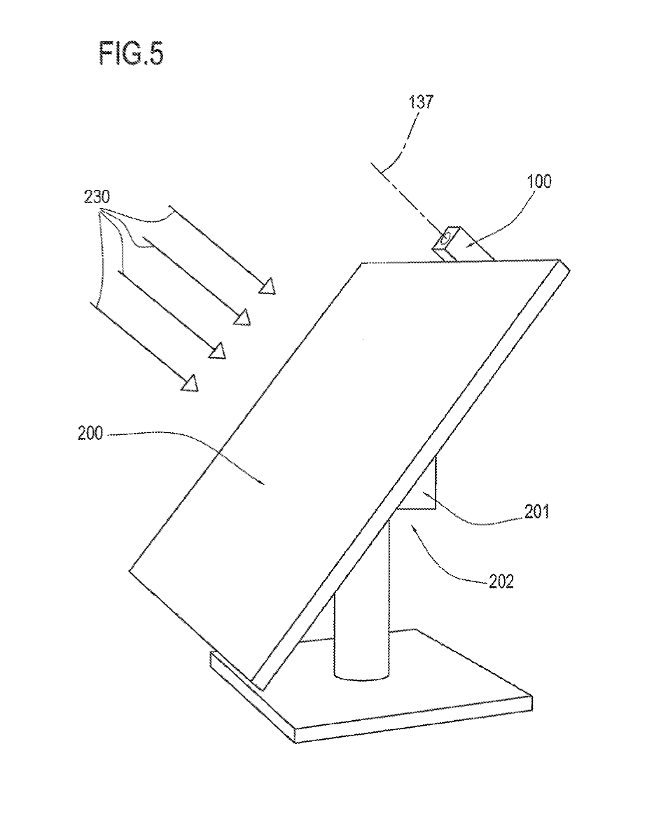

With reference to FIG. 4, it may be observed, in a schematic view, how the outside of the instrument 100 appears.

The container 123 is preferably impermeable and watertight, and comprises a support 120,

Preferably, the support 120 comprises a plurality of mechanical regulations, not illustrated, which allow finely regulating the inclination of the instrument 100 with respect to the plane on which the instrument 100 itself is fixed.

As mentioned, one of the external surfaces of the container 123 has the aperture 301 in which the cited essentially transparent window 109 is set which allows the direct solar radiation to enter inside of the instrument 100.

As illustrated and mentioned, the instrument 100 is connected to an external computer 130 by means of a communication system 110 preferably completed by an electrical connection or alternatively and preferably by a wireless connection.

Looking in more detail relative to the filter holder wheel 105, with reference to FIG. 2, it should be noted that, as mentioned, the revolving filter holder support 106 rotates around the axis 112.

The support 106 hosts a plurality of filters 105 which are positionable along the optical path in such a way that the instrument 100 is able to acquire images front the source 133 at different wavelengths based on the filter used.

In a preferred embodiment illustrated, the filters allow the passage of the wavelengths 500 nm, 700 nm and 990 nm.

Preferably, the fillers 105 are installed on the wheel 106 at a constant distance “d” from the axis 112.

The synchronisation of the shoot of the sensor 101 with the passage of one of the filters 105 along the optical path is appropriately indicated.

In particular, the support 106 comprises a plurality of references 115 and 124.

Preferably, in the configuration illustrated as example, the references 135 are each completed by a deep cat bored into the border 106a of the filter holder support 106 and are foreseen to be radially aligned with a relative filter 105.

The instrument 100 comprises, as mentioned, an opto-electronic optocoupler 111 of the basically known type.

In particular, the optocoupler 111 allows giving the picture-taking command to the sensor 101 to the passage of the references 115, or rather, when one of the bandpass filters 105 is inserted along the optical path. Advantageously, the filter holder wheel 106 is realized in such a way that one of the references, indicated for clarity with the reference 124 in FIG. 2, is positioned on the wheel 106 in such manner that, when the optocoupler 111 intercepts the reference 124, the rotating filter holder support 106 essentially intercepts all of the luminous radiation entering in the window 109.

In practice, a filter 105 does not correspond to the reference 124, but to the body of the wheel 106 which intercepts the luminous radiation and completes the cited shutter 117.

In this way, at the moment of the acquisition corresponding to the reference 124, there will correspond a black image which allows the ordering of the images acquired by means of the filters 105.

Each filter 105 allows the acquisition of an image of the luminous source taken hat a precise wavelength.

However the result of a sequence of pictures would be a succession of images that do not allow attributing, for each image, the wavelength of acquisition, or rather, of the filter 105 in use at that moment.

The presence in the succession of images of the acquired image in correspondence with the reference 124 allows the ordering of the others and allows to know, for each image, the acquisition wavelength.

FIG. 3 shows a second embodiment of the instrument 100 according to the present invention.

The instrument 100 is described in a detailed way relative to the differences from the implementation form previously described.

The instrument 100 comprises the sensor 101 equipped with a pixel matrix, mounted on a printed circuit 102. The sensor 101 is enclosed in the optical camera 103 on which h affixed the optical system 104 whose focal, plane lies on the sensitive surface of the sensor 101. The sensor 101 converts the image created by the optical, system 104 info an electrical signal, either analogical or digital, which is sent by means of the communication system 110 to the external computer 130.

It may be observed that in this embodiment, the instrument 100 comprises only one bandpass filter 116.

The filter 116 is inserted in the optical path of the instrument 100 and is included in the same optical path.

The filter 116 separates the spectrum, of the incident radiation 128 into two complementary spectral bands.

A first almost monochromatic band of radiation 129 is transmitted toward the sensor 101, while a second portion, complementary to said first portion 129 is reflected toward the outside.

The command for the recording of the image is supplied to the sensor by the external computer 130.

Alternatively, the instrument 100 comprises a timer, schematized in a dotted line with a relative lock 131, preferably foreseen in the sensor 101.

The timer 131, as mentioned, supplies the command for the recording of the image to the sensor 101.

In a preferred embodiment illustrated, along the optical path there is also inserted the neutral density attenuator filter 108 and the protective window 109.

Preferably, the filter 1.08 and the window 109 are kept in position by the support 125 which acts to maintain constant their inclination with respect to the optical, axis of the system with the aim of avoiding reflections toward the sensor 101.

FIG. 5 shows schematically an applicative form of the instrument 100.

Given a plurality of parallel solar converters 200, the instrument 100 is firmly mounted to the support structure 202 of the converters.

The instrument 100 Is positioned in such a way that its optical axis 137 is basically aligned with the direction perpendicular to the surface identified- by the solar converters 200.

The support structure 202 comprises a movement system 201 or solar tracking, which sets to align the normal to the plane of the solar converters 200 with the direction from, which the solar rays 230 originate.

Advantageously, the instrument 100 allows to verify that the positioning system 201 is effective and operates in such a way that the energy produced by the converters 200 is maximized.

The optical system 104 of the instrument 100, according to this invention, enables the creating of the image of a luminous source, specifically and preferably of the solar source, indicated by the reference 133 in FIG. 1, on the sensor 101 equipped with the pixel matrix.

The sensor 10.1 is advantageously able to convert the radiant intensity of said image into an electrical signal which can then be digitallxed. Preferably, the sensor 101 is of the CCD type or, alternatively, CMOS.

The sensor 10.1 comprises, as mentioned, an active area or sensitive surface 134 of a basically known type.

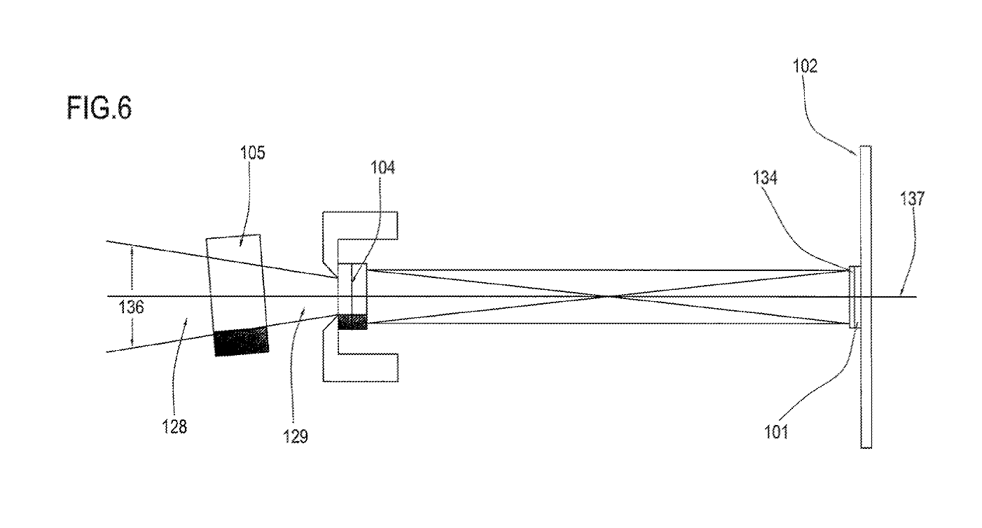

With particular reference to FIG. 6, it may be observed that the active area 134 of the sensor 101 identifies, as mentioned, by means of the optical system 104, a portion 136 of the space defined as “field of view”.

The field of view is such that possible point-like isotropic luminous sources, positioned into said field of view, having at least a first fraction of the radiation emitted which is sent by the optical system 104 onto the sensitive surface 134 of the sensor.

Along the optical path which the radiation travels to arrive at the sensor 101 there are placed optical bandpass filters 105 which transmit the first portion of the incident radiation 129 toward the sensor 101.

As mentioned, the filters 105 reflect or absorb the portion of the spectrum complementary to that portion 129. In this way it is possible to create, on said, sensor 10L almost monochromatic images of the solar source, or rather, images containing a reduced band of wavelengths.

The band of wavelengths, or rather, the band of the portion 129 of the spectrum transmitted to the sensor 101 is preferably less than 50 nm and even more preferable less than or equal to 10 nm in such a way as to be able to consider the spectral response of the photoelectric sensor 101 constant for that wavelength interval.

When the sun lies within the held of view 136 of the optical system 104, its image is created on the sensitive surface 134 of the sensor 101. The interposition of one of the filters 105 allows the rendering of the basically monochromatic image which is created on the sensor.

Advantageously, the instrument 100 comprises a polarizing filter 113 to attenuate the intensity of the radiation which reaches the sensor 101.

Preferably, the instrument 100 comprises a plurality of miters 113 appropriately combined.

In practice, the polarizing filters, appropriately combined, perform the same function of the attenuator filters 108.

In order to guaranteeing the protection of at least the optical system 104 from external atmospheric agents, the instrument 100 comprises a transparent optical protection 114.

The monochromatic images collected by the sensor 101 are sent in digital format through the communication system 110, an electrical or wireless type, to the computer 130.

Preferably, the sensor 101 is set to acquire images at the maximum frequency possible.

The computer 130 calculates, from the images collected by the sensor 101, an irradiance map on the plane of the sensor itself 101.

More precisely, the computer 130 calculates the irradiance map on the plane of the sensor 10.1 thanks to the spectral response curve of the sensor itself 101.

In order that the result of the calculation of the irradiance is precise, it is necessary that the value of the spectral response of the sensor 101 be constant within the interval of wavelengths which contribute to creating the individual monochromatic images.

Thanks to the calculation of the inverse propagation of the rays from the sensor to the entrance surface of the optical system 104, it is possible to compute the power spectral density of the incident radiation 128 on the instrument 100.

Advantageously, in fact, it is appropriate that the instrument 100 supply indications of the power spectral density of the radiation at the entrance of the optical system which is different from the spectral density of the radiation on the sensor.

The power spectral density of the radiation at the entrance of the optical system corresponds, in application, to the power spectral density of the radiation on the converters.

The sensor, in tact, supplies the spectral density on the plane of the sensor itself. The spectral response curve supplies an indication as to how to pass from the arbitary digital units at the power

$$( \frac{W}{{m}^{2}} )$$

to a predetermined wavelength on the sensor.

For the present discussion, there is of interest the power entering the optical system 104 which acts as a concentrator of the power on the sensor 101 and, therefore, it is necessary to calculate the power at the entrance.

Advantageously, such calculation, is based on the intrinsic angular divergence of the sun so as to be able to calculate the power entering the optical system before its concentration on the sensor due to the instrument's optical system.

In other words, the instrument 100 is equipped with a digital camera, defined in brief by the sensor 101 and by the optical system 104, which is able to collect a plurality of monochromatic images of the solar source corresponding to different wavelengths. Said plurality is commonly indicated as ‘datacube’.

The ‘datacube’ is men sent to the computer 130 which, thanks to a calculation methodology described better further on, allows the extracting of the angular distribution of the incident radiation and a measurement of the direct irradiance on the normal plane in the direction from which the rays originate. The successive analysis of the ‘datacube’ allows the representation of the temporal evolution of the two parameters calculated by the computer (angular distribution of the radiation, and irradiance on the normal plane of the radiation).

Thanks to the digital elaboration of the single images of each datacube it is possible to extract a plurality of Information for the evaluation of the conversion efficiency of the converters 200 and of the reliability of the system of solar tracking 20.1.

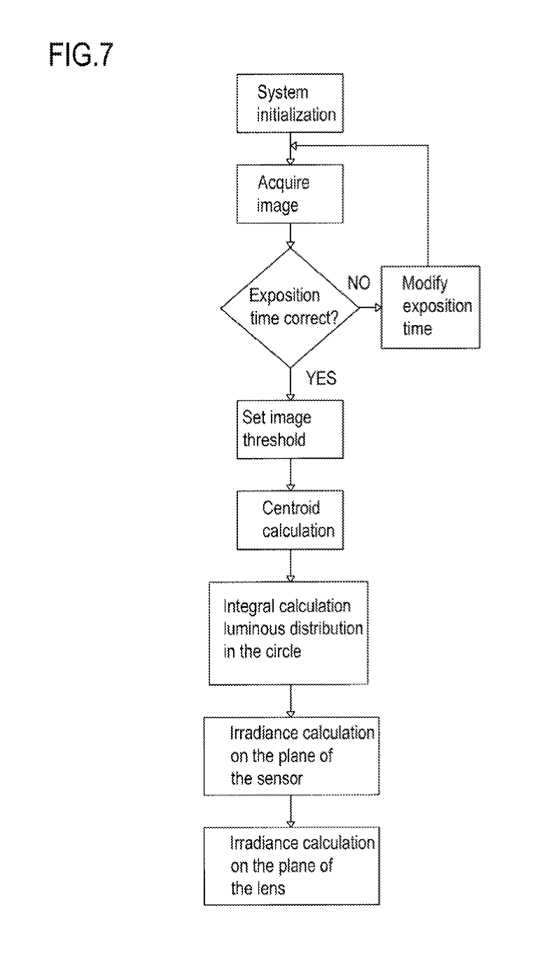

To extract the direct irradiance on the entire solar spectrum, starting from a reduced number of measurements of the power spectral density extracted by the corresponding images acquired by the sensor 101 at predetermined wavelengths, as mentioned, a preferred procedure of calculation has been identified; described further on with reference to FIG. 7. More specifically, the sensor measures an intensity which corresponds to an energetic content. Knowing the bandwidth thanks to the filter 105 used, the power spectral density is extracted, or rather the energetic content of the band which is passed through the filter 105 measured in

$$\frac{W}{{m}^{2} nm} .$$

Using the plurality of monochromatic Images or ‘datacube’, the computer 130 calculates the direct Irradiance on the normal plane in the direction from which the solar rays originate.

Advantageously, the calculation of the Irradiance occurs without the help of an added wide band Instrument such as the pyrheliometer.

Preferably, the computer 130 calculates the angular distribution of the incident radiation and identifies its ‘centroid’ or ‘central point’. The comparison of mom ‘datacubes’ acquired in successive instances allows precisely calculating the angular movement between the optical axis 137 of the instrument 100 and the direction from which the rays originate 230. This parameter establishes the essential element for evaluation of the angular error committed by the tracking system. The computer 130 allows, moreover, the recording of the temporal evolution of the error committed by the tracking system 201 and the representing of it in the form of a graphic or table.

In a fust form of implementation, according to the present invention, the procedure for calculating the irradiance on the normal plane in the direction from which the external luminous radiation originates comprises an acquisition step in which are collected, by the Instrument 100 a plurality of basically monochromatic images, or rather, presenting a predetermined wavelength.

The procedure comprises a calculation step of the irradiance in which, for each of the essentially monochromatic images acquired by the sensor 101 there is calculated the irradiance map on the plane of the- sensor 101.

The procedure comprises a second calculation step in which, for each of the wavelengths for which each of the images has been acquired, is calculated the angular distribution of the luminous intensity.

The procedure comprises a third calculation step in which, for each of the wavelengths for which each of the images has been acquired, is calculated the angular distribution of the luminous intensity.

The procedure comprises a fourth calculation step in which, for each of the wavelengths for which each of the images has been acquired, is calculated the power spectral density on entry in the instrument 100.

The procedure comprises a fifth calculation step in which, by means of a combination of the power spectral densities, the irradiance on the plane perpendicular to the direction of the origin of the radiation is calculated.

Referring to the flow chart shown in FIG. 7 attention is drawn to the following.

The image which the system 1 acquires must not be saturated, or rather must not be all white or all black.

In an initialisation step, corresponding to the “System Initialisation” block the speed of acquisition of the images is specifically configured.

Once the image is acquired (“Acquire Image”), it is then verified that the exposition time is correct (“Exposition time-correct”), or rather, that the image is not saturated. In such a case, the exposition time is modified (“Modify exposition time”) and the image Is acquired again.

At the end of the acquisition of the image, particularly of the Sun, for the calculation of the centroid (“Centroid Calculation”), it is necessary to eliminate from the calculation the pixels for which there is an unwanted noise, or rather, the computer is set to consider, for the calculations, only the pixels which have a value above a predetermined threshold (“Set image Threshold”).

In other word, the system 1 verifies if the exposition time is correct. It is set a threshold value for the image if the check, is true; the exposition time is corrected and a new image of the luminous source is acquired if the cheek is false. A threshold is set for eliminating pixels to which corresponds an unwanted noise from, the calculation and the image centroid is calculated.

The digital value of the interested pixels is then integrated (“Integral Calculus Luminous Distribution in the Circle”),

As mentioned, the irradiance on the plane of the sensor 5s then calculated (“Irradiance Calculation On the plane of the sensor”) and afterwards on the plane of the lens (“Irradiance calculation on the plane of the lens”), or rather at the entrance of the optical system 104.

A procedure for the calculation of the angle of misalignment between the optical axis of the instrument 100 and the direction from which the external luminous radiation of interest originates is also part of present invention.

This procedure comprises an acquisition step of the image of the luminous source.

In a first calculation step, the Intensity map of the plane of the sensor 101 is determined.

In a second calculation step, the centroid of the luminous distribution corresponding to the external luminous source is determined.

In a third calculation step, the distance between the centroid and the centre of the sensitive surface 134 of the sensor is determined.

In a fourth calculation step, the angle corresponding to the misalignment between the optical axis 137 of the instrument 100 and the average direction from which the luminous rays originate is calculated.

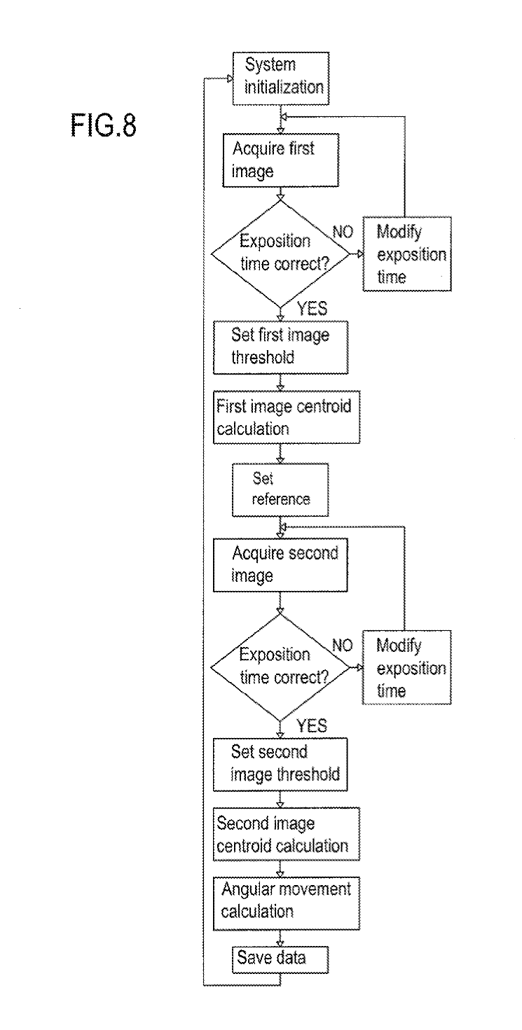

A procedure for the calculation of the angle of misalignment between two successive positions of the instrument 100 is also part of the present invention, as schematically shown in FIG. 8.

In the initialization step corresponding to the “System initializaion” block, the images acquisition velocity is set.

The procedure for the calculation of the angle of misalignment between two successive positions of the instrument 100 comprises an acquisition step of the first Image of the luminous source (“Acquire first image”).

Once the first image is acquired, it is cheeked that the exposition time is correct (“Exposition time correct”) rather then that the first image is not saturated.

If the image is saturated, the exposition time is modified (“Modify exposition time”) and the image is acquired again.

The pixels for which corresponds an unwanted noise should be eliminated in order to acquire the image, in particular of the Son, for the centroid calculation.

In other words, the elaboration unit is forced to consider only the pixels which have a value greater than predetermined threshold (“Set first image threshold”).

Afterwards, the intensity map on the plane of the sensor 101 is calculated.

The procedure then comprises a calculation step of the coordinates of the centroid (“First image centroid calculation”) of the luminous distribution corresponding to the first image of the external luminous source and a memorization step of such coordinates (“Set reference”).

Then, a second image of the luminous source is acquired in an instant of time following that of the acquisition of the first image (“Acquire second image”).

Once the second image is acquired, it is checked that the exposition time is correct (“Exposition time correct?”) rather then that the second image is not saturated.

If the image h saturated, the exposition time is modified (“Modify exposition time”) and the image is acquired again.

The pixels for which corresponds an unwanted noise should be eliminated in order to acquire the image, in particular of the Son, for the centroid calculation.

In other words, the elaboration unit is forced to consider only the pixels which have a value greater than predetermined threshold (“Set second image threshold”).

Relative to this second acquisition, the intensity map on the plane of the sensor 101 is calculated.

The procedure then foresees calculating the coordinates of the centroid of the luminous distribution corresponding to the second image of the external luminous source (“Second image centroid calculation”) and a memorization step of such coordinates.

The procedure then comprises a calculation step of the vector which identifies the variation of the coordinates of the two memorized centroids. The procedure then comprises a step of calculation of the angle of misalignment identified by the vector extracted at the previous point (“Angular movement calculation”). In the block diagram of FIG. 8, as mentioned above, the steps described are together with the calculation steps which are basically analogous to those previously described.

The invention as described achieves important advantages.

The electro-optical system of measurement, as mentioned, allows the calculation of global irradiance, or rather, integrated on the entire spectrum, of wavelengths, beginning from at least one monochromatic radiation and, therefore, presents an extremely simpler architecture with respect to known instruments.

The instrument 100 allows notably reducing the complexity of spectroradiometric Instruments for the measurement of solar irradiance.

The instrument 100 allows the limiting of monochromatic detections to a few wavelengths,

In particular, since the band within which it is necessary to carry out the measurements is relatively limited, it is possible to use a silicon sensor 101, whose spectral response band typically ranges from 300 nm to 1100 nm.

Among the various typologies of silicon photosensitive elements which can be used according to the present invention, there are, according to their internal, structure, the pixel matrices commonly indicated as CMOS, CCD, or PSD sensors.

The matrix sensors of the CMOS, CCD, or PSD type oiler, moreover, the possibility of achieving the spatial distribution of radiant intensity on the plane of the photosensitive elements.

Preferably, the optical system 104 of the instrument 1 comprises achromatic lenses, so that, placing the active surface of said sensors on the focal plane of an achromatic lens which corrects chromatic aberrations, it is possible to associate, to each point of the image plane, a particular direction from which the rays originate and, therefore, to each pixel of the sensor 101.

In this way, it is possible to extract the angular distribution of the image on the sensor 101 independently of the wavelength.

From the image collected by the sensor 101 it is possible to extract, with the appropriate calculations, the angular distribution of the incident radiation and, therefore, the alignment error between the direction from which the rays originate and the optical axis of the instrument.

Interposing a bandpass filter along the optical path, with the relative bandwidth reduced, the radiation which reaches the sensor 101 can be considered, to all effects, monochromatic and, therefore, it is possible to obtain the angular distribution of the radiation/or a specific wavelength.

The procedure, as described, allows, starting from a plurality of monochromatic Images of different wavelengths, detecting the angular distribution of the radiant intensity and the direct global irradiance to which the instrument 1.00 is exposed. These two pieces of information make op the fundamental parameters which it is necessary to know for evaluating both the conversion efficiency of a solar tracking system and for estimating the pointing error with elevated precision.

The present invention is, therefore, relative to an optoelectronic system comprising essentially a digital camera equipped with attenuating filters of neutral density and one or more optical bandpass filters that are able to collect a series of monochromatic Images which are these elaborated by a computer system with the goal of detecting the angular error between the- direction, from, which the solar rays originate and the optical axis of the instrument itself.

Tire instrument 100 also allows the extracting of the angular distribution of the power spectral density for each of the monochromatic images collected by the camera.

The instrument 100 allows the obtaining of an indication of the direct solar Irradiance extrapolated for the entire spectrum of solar emission beginning with acquisitions of monochromatic images.

The instrument 100 can advantageously be firmly mounted to the support structure of a solar tracking system for photovoltaic or thermal modules and acts, therefore, to show an indication of the error committed by the tracking system. The instrument 100 contemporaneously allows the supplying of a measurement of direct solar irradiance on the plane perpendicular to the solar radiation.

1. An electro-optical system for radiometric measurement of luminous radiation emitted by a luminous source characterised by the fact of including:
an instrument comprising a sensor which includes a pixel matrix for recording at least one image of said luminous source:
an optical system associated with said sensor for creating the image of said luminous source on said sensor, said sensor and said optical system define the field of view of said instrument;
said instrument comprises, moreover, at least one bandpass filter intercepting said field of view, in such a way that said image is essentially monochromatic, said system comprises a computer associated to said sensor for acquiring said essentially monochromatic image and for determining the irradiance of said luminous source starting with said essentially monochromatic image.

2. An electro-optical system according to claim 1, characterised by the fact that said computer allows the calculation of the angular distribution of said luminous radiation starting from said monochromatic image.

3. An electro- optical system system according to claim 1, characterised by the fact that said bandpass filter has a passband of 700 nm.

4. An electro-optical system according to claim 1, characterised by the fact that said instrument comprises a plurality of bandpass filters each of which is characterised by its respective passband and means of positioning operatively active on said bandpass filters necessary for positioning said bandpass filters in the field of view of said instrument.

5. An electro-optical system according to claim 4, characterised by the fact that said means of positioning comprises a revolving filter holder around a rotation axis, said bandpass filters being installed on said holder.

6. An electro-optical system according to claim 1, characterised by the fact that said instrument comprises the means of piloting said sensor associated with said sensor for sending a remote command to said sensor thus acquiring said essentially monochromatic image.

7. An electro- optical system according to claim 5, characterised by the fact that said means of piloting comprises an optocoupler associated to said holder presenting a plurality of references each of which corresponds to one of the said bandpass filters, said optocoupler supplying a remote command in correspondence to an alignment with one of the said references.

8. An electro-optical system according to claim 7, characterised by the fact that said holder comprises a shutter and presents a second reference in correspondence to said shutter, said optocoupler supplying a remote command to said sensor in correspondence to an alignment of said second reference, said field of view proving to be obscured by said shutter.

9. An electro-optical system according to claim 1, characterised by the fact that said instrument comprises at least one attenuator filter of neutral density placed between said sensor and said luminous source attenuate the intensity of said radiation.

10. An electro-optical system according to claim 1, characterised by the fact that said instrument comprises at least one polarising filter placed between said sensor and said luminous source to attenuate the Intensity of said radiation.

11. An electro-optical system according to claim 1, characterised by the fact that said computer is integrated into said instruments.

12. A procedure for calculating the irradiance of a luminous radiation originating from a luminous source, characterised by the fact of comprising the phases of:
acquisition of a plurality of essentially monochromatic images of said source by means of an electro-optical system for radiometric measurements according to claim 1:
calculation of the irradiance map of the sensor plane for each of the essentially monochromatic images acquired by the instrument;
calculation of the angular distribution of the luminous intensity for each of the wavelengths for which the images have been acquired;
calculation of the power spectral density at entry to the Instrument for each of the wavelengths for which the essentially monochromatic images have been acquired;
calculation of the irradiance of the plane perpendicular to the direction of the origin of the luminous radiation by means of a linear combination of said power spectral density.

13. A procedure for the calculation of the angle of misalignment between the optical axis of the electro-optical system for radiometric measurements according to any of the claim 1 and the direction from which the external luminous radiation originates, said procedure characterised by the fact of comprising the phases of:
acquisition of the image of the luminous source;
calculation of the intensity map on the plane of the sensor;
calculation of the centroid of the luminous distribution corresponding to the image of the luminous source;
calculation of the distance between said centroid and the centre of the sensitive area of the sensor;
calculation of the angle corresponding to the misalignment between the optical axis of said instrument and the average direction from which the luminous radiation originates.

14. A procedure for the calculation of the angle of misalignment between two successive positions of an instrument of measure being part of the electro-optical system for radiometric measurements according to claim 1 characterised by the fact of comprising the phases of:
acquisition of a first image of the luminous source;
calculation of the intensity map corresponding to said first image on the plane of the sensor;
calculation of the coordinates of the centroid of the luminous distribution corresponding to said first image and the memorisation of such coordinates;
acquisition of a second image of the luminous source an instant of time successive to said first image;
calculation of the intensity map corresponding to said second image on the plane of the sensor;
calculation of the coordinates of the centroid of the luminous distribution corresponding to said second image and the memorisation of such coordinates;
calculation of the vector which identifies the variation of the coordinates of the two memorised centroids;
calculation of the angle of misalignment identified by said vector.
